(19) United States
(12) Patent Application Publication
(10) Pub. No.: US 2025/0283362 A1
(43) Pub. Date: Sep. 11, 2025

(54) TWO-ROLLER SWIVEL ARM

(71) Applicant: Bode - Die Tür GmbH, Kassel (DE)

(72) Inventors: Ulrich Arend, Dickershausen (DE); Chris Thöne, Kassel (DE); Andreas Pellegrini, Edermünde (DE)

(21) Appl. No.: 19/071,121

(22) Filed: Mar. 5, 2025

(30) Foreign Application Priority Data
Mar. 5, 2024 (DE) 20 2024 101 080.9
Dec. 6, 2024 (DE) 10 2024 136 461.0

(51) Int. Cl. E05D 15/10

(52) U.S. Cl. CPC E05D 15/101; E05Y 2201/624; E05Y 2201/684; E05Y 2201/688; E05Y 2900/531

(57) ABSTRACT

A system with a leaf for closing an opening, which is arranged on a frame. This system includes a swivel arm arranged fixed on the frame and swivellable about a vertical axis, the free end of which is guided on the leaf in a guide rail extending along a longitudinal direction in an opening direction and which is aligned in a closed position of the leaf in a first position roughly in the longitudinal direction and in an open position of the leaf in a second position roughly in a transverse direction. The system includes a deflection element on the guide rail to bring about a swivelling of the swivel arm between the first and second positions and a movement of the leaf in transverse direction. The system includes a stop face in the guide rail for the free end of the swivel arm to bear on the stop face.

### CROSS-REFERENCE TO RELATED APPLICATIONS

This application claims the benefit of German patent application no. 20 2024 101 080.9, filed on 5 Mar. 2024, and German patent application no. 10 2024 136 461.0, filed on 6 Dec. 2024, the disclosures of which are incorporated herein by reference in their entirety.

### TECHNICAL FIELD

The present disclosure relates to a system with a leaf for closing an opening which is arranged in a frame. The disclosure essentially relates to a door system with a door leaf, which can be moved from a closed position into an open position and back.

### BACKGROUND

Such door systems are used in particular in rail-borne vehicles, such as for example tramways or trains, but they are also used in road vehicles such as buses.

For example, door systems are known in which the door leaf is moved out of the door opening and back into the latter via a rotation column. In door systems without a rotation column, for example door systems with lateral locking, a lateral rotary catch or a lockable swivel arm, use is usually made of a swivel arm with three rollers in combination with a sheet-metal guide rail in the door leaf and kinematics adapted thereto. The door system is subject to relative play due to components, for which reason swivelling-in of the door leaf does not take place reliably in all installation situations. Each position deviation of each of these components requires a new kinematic design and new components. In addition, the system is subject to a relatively high degree of wear inherent in the system.

The problem of the disclosure consists in creating a system with a leaf for closing an opening which is arranged in a frame, which can be used as an alternative to the already known door systems. The leaf should be able to be transferred securely into its locked closed position in almost any possible vehicle position. Furthermore, the problem consists in proposing a method for opening and closing an opening with a leaf.

### SUMMARY

The problem is solved with a system and a method according to the independent claims.

According to the disclosure, the system comprises the following components;
a swivel arm arranged fixed on the frame and swivellable about a vertical axis Z-Z, the free end of which is guided on the leaf in a guide rail extending along a longitudinal direction X-X into an opening direction and which is aligned in a closed position of the leaf in a first position roughly in longitudinal direction X-X and in an open position of the leaf in a second position roughly in a transverse direction Y-Y,
a deflection element on the guide rail, which is designed and arranged in such a way that it brings about a swivelling of the swivel arm from its first position into its second position and a movement of the leaf in transverse direction Y-Y, when the leaf is moved out of the closed position into an open position and the free end of the swivel arm contacts the deflection element,
a stop face in the guide rail, which is designed and arranged in such a way that the free end of the swivel arm comes to bear on the stop face when the leaf moves out of the open position in the closing direction and brings about swivelling of the swivel arm from its second position into its first position and a movement of the leaf in transverse direction Y-Y.

In a particularly advantageous variant of embodiment, the system is characterised in that:
the swivel arm comprises a first roller and a second roller, which also each rotate about vertical axis Z-Z,
the guide rail comprises a roll-off wall extending parallel to the main extension of the leaf along longitudinal direction X-X and a stop face arranged at a front end of the guide rail in the opening direction of the leaf,
a starting wedge pointing in the opening direction is arranged as a deflection element in the opening direction of the leaf at the front end of the guide rail and at the rear side of the stop face,
   wherein
the first roller is arranged outside the guide rail, in such a way that in the closed position of the leaf it is arranged in front of the starting wedge in the opening direction,
the second roller is arranged inside the guide rail behind the roll-off wall and rolls off on the roll-off wall,
the components of the system are arranged and aligned with one another in such a way that, when there is a movement of the leaf,
   a. the first roller rolls off on the starting wedge from the closed position in the opening direction and brings about swivelling of the swivel arm from the first position into the second position,
   b. the second roller comes to bear on the stop face from the open position in the closing direction and brings about swivelling of the swivel arm from the second position into the first position.

In a particularly advantageous variant of embodiment with two rollers, the latter form as it were the free end of the swivel arm. The two rollers are arranged beside one another in the closed position of the leaf or in the first position of the swivel arm along longitudinal direction X-X. As a result of the rolling-off of the outer first roller on the starting wedge during the opening procedure and the pressure of the inner second roller on the roll-off wall, the swivel arm swivels with the two rollers, which are then arranged beside one another in transverse direction Y-Y and slightly obliquely offset with respect to one another during the opening movement and also in the open position. The roll-off wall, on which the inner second roller rolls off during the movement of the leaf, is moved between the two rollers with further movement of the leaf.

The system according to the disclosure is extremely cost-effective, since it is formed from only a few components. Due to the fact that the swivel arm, by contact of its free end or the first roller on the deflection element or starting wedge, brings about the movement of the leaf in the transverse direction, the entire movement sequence is free from play. The same applies during the movement from the open position into the closed position, the contact of the second roller with the stop face brings about controlled swivelling of the swivel arm and thus of the leaf into the opening.

The rotary axes of the two rollers are arranged parallel or at least almost parallel to the rotary axis of the swivel arm.

Instead of the rollers, the use of different kinds of sliding elements is also possible, although non-rolling sliding elements may increase the resistance during the movement process.

In the case of conventional swivel arms and rotation columns, new kinematics are always used, depending on how large the desired stroke is intended to be, so that the geometry has to be changed dependent thereon. In the system according to the disclosure, on the other hand, the swivel arm can simply be positioned farther inwards or outwards in the portal in order to cover the desired area and does not therefore require new kinematics. During planning or construction, the swivel arm can more or less simply be displaced inwards or outwards, without other components having to be adapted. In the closed final position, the angular position of the swivel arm alone is thus merely changed somewhat.

The kinematics is thus independent in lift ranges between 50 and 80 mm, preferably between 54 and 74 mm. For example, the swivel arm with a length of approximately 7 cm (from the rotation point up to the first roller) can be used with doors which have a lower lift of the leaf when opening between 50 and 80 mm.

The guide rail is integrated into the leaf in such a way that the inner second roller is guided in the region that is not visible. The guide rail can for example be painted in the same colour as the leaf, i.e. have the same colour as the leaf in order to be integrated optically better into the overall picture.

An essential feature of the disclosure consists in the fact that the swivel arm is also swivelled indirectly by the drive of the leaf. It is not therefore necessary to provide an independent drive for the swivel arm. The latter is jointly moved or swivelled automatically via the moving leaf.

The system according to the disclosure is particularly well suited for use as a door system. The swivel arm or swivel arms are thereby fastened to the door frame or door portal and the door leaf is moved by the inventive system in the Y-direction (usually the transverse direction of the vehicle) out of the door opening and then in the X-direction along the vehicle outer wall. In the closing procedure, the movement is carried out in the reverse direction and sequence. The system can be used for door systems with only one door leaf, but in particular also for door systems with two door leaves. The door drive is usually arranged above or below the door opening. The door leaves are moved for example via a spindle or a rack and pinion drive.

Independently of this, however, the system is also suitable for other types of doors or windows. The system can also be used advantageously for rooflights, for example of mobile homes of travel trailers. In this case, the directions used in this description (X-, Y-and Z-direction) should be adapted accordingly.

The essential elements of the guide rail can be designed in one piece or be formed from a number of individual elements. For example, the deflection element and the stop face can be provided by inherent components.

The starting wedge represents a deflection element, which deflects the force applied by the drive and the movement direction from the X-direction briefly into a Y-direction in order to place the leaf parallel. The leaf is thus swivelled and then further displaced along the X-direction. The starting wedge can comprise an inclined face on its outer contour, on which the first roller rolls off, but the latter can also be implemented by a rounded-off convex shape.

The system according to the disclosure, moreover, also brings about an above-dead-centre position and thus a stabilisation in the opened state of the leaf. This above-dead-centre position is supported or caused by the inherent weight of the leaf. This results from a rotary point above on the drive. As a result of the inherent weight acting downwards, the door leaf rotates about this rotary point and the door leaf is held close to the carriage body.

Without further swivelling of the swivel arm, it is not possible to move the leaf in transverse direction Y-Y. For this purpose, the deflection element first has to be brought into the region of the first outer roller in order that the latter can move in the Y-direction.

### BRIEF DESCRIPTION OF THE DRAWINGS

The disclosure is explained in further detail with the aid of the following figures. The latter show only one particularly advantageous example of embodiment, the individual components can also be used independently of one another and/or with one another a different arrangement.

In the figures:

FIG. 1: a system according to the disclosure in the open position,

FIG. 2: a system according to the disclosure in the closed position,

FIG. 3: a swivel arm according to the disclosure,

FIG. 4: the swivel arm according to the disclosure in connection with a guide rail in the closed position in plan view,

FIG. 5: the swivel arm according to the disclosure in connection with a guide rail in an intermediate position in plan view,

FIG. 6: the swivel arm according to the disclosure in the open position in plan view, and

FIG. 7: an anti-lift device of the leaf in detail.

### DETAILED DESCRIPTION OF THE DRAWINGS

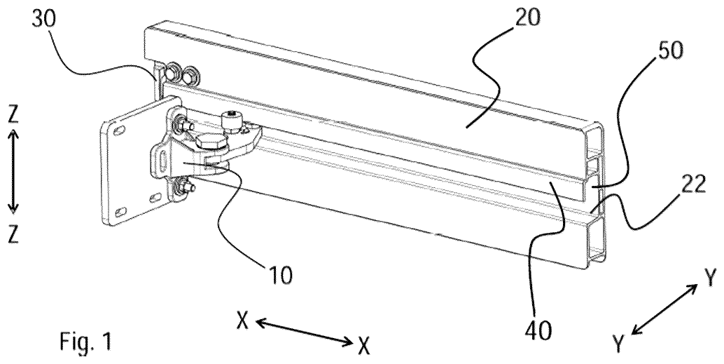

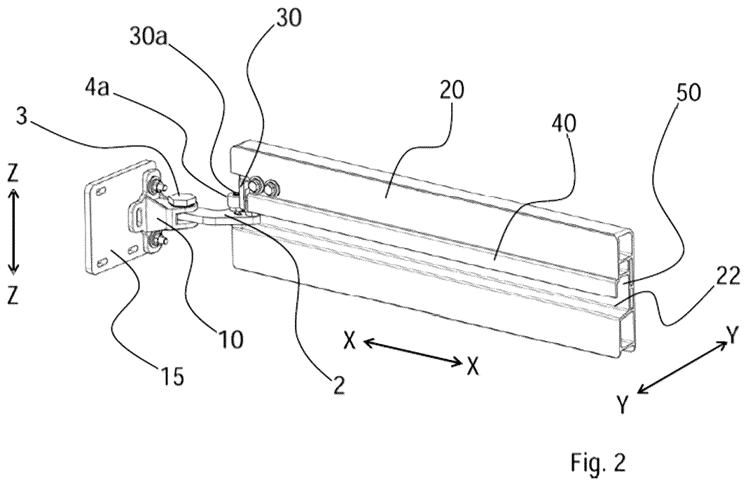

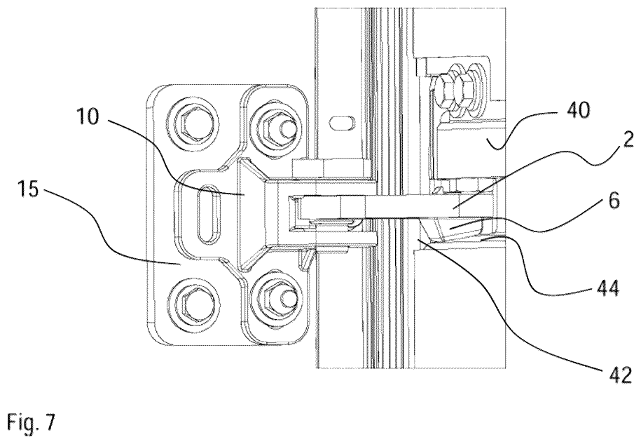

FIG. 1 shows the guide system in the open position and in an intermediate position, FIG. 2 in the closed position. A guide rail 20 is a direct part of a leaf 42 represented only in FIG. 7 for closing an opening, which when used as a door system is preferably integrated into a corresponding door profile, i.e. door leaf 42 not shown. Guide rail 20 thus moves with leaf 42 in the opening and closing direction, in the example of embodiment shown along a longitudinal direction X-X.

A deflection element 30 is arranged in front of guide rail 20 at the end of guide rail 20 in the opening direction of leaf 42 and is preferably screwed to guide rail 20. Deflection element 30 thus forms the starting wedge, which brings about the movement of a swivel arm 2 and thus also of leaf 42 out of the opening. In the example of embodiment shown, this is brought about via an arc-shaped convex outer contour 30a.

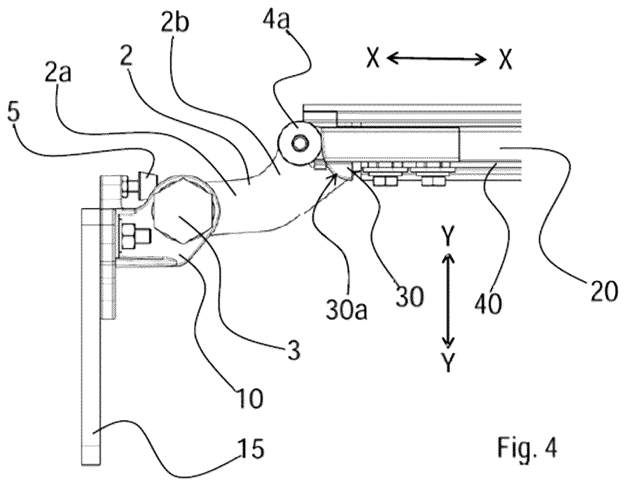

Leaf 42 moves from the first position shown in FIG. 4 (closed position) to the second position (open position) not only along longitudinal direction X-X, but also along a transverse direction Y-Y. During the opening movement of leaf 42 in longitudinal direction X-X, deflection element 30 is moved with its outer contour 30a towards a roller 4a and, on account of convex outer curvature 30a, the drive force acting on leaf 42 in longitudinal direction X-X is deflected into a force acting in transverse direction Y-Y, which moves leaf 42 out of the door opening. After first roller 4a has passed deflection element 30, the further movement of leaf 42 again takes place along longitudinal direction X-X.

In order to bring about the swivelling movement or the movement in transverse direction Y-Y, swivel arm 2 is mounted in a swivelling manner on a base plate 10 by means of a bearing bolt 3. Base plate 10 is fixed stationary directly or via an additional adapter plate 15 to the frame or to the vehicle portal or door portal (not represented). Bearing bolt 3 enables swivelling about a vertical axis Z-Z. Swivel arm 2 thus swivels from a first position, which corresponds to the closed position of leaf 42, into a second position, which corresponds to the open position of leaf 42, and back.

Furthermore, guide rail 20 forms a guide track 22, in which a second roller 4b is guided. In the example of embodiment shown, guide track 22 is formed by a groove 50, which is limited on its side facing the opening by a roll-off wall 40. In this example of embodiment shown, second roller 4b extends into groove 50 and, in guide path 22, runs off on the inner side of roll-off wall 40, whereas first roller 4a is guided on the outer side of run-off wall 40 parallel to the latter. First roller 4a can also roll off on the outer side of roll-off wall 40 during the movement of leaf 42, but it can also be guided at a distance parallel to roll-off wall 40 and along roll-off wall 40.

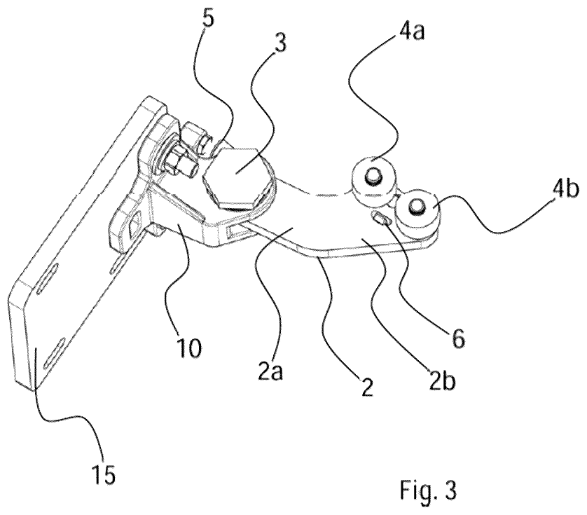

FIG. 3 shows that swivel arm 2 at its free end carries both rollers 4a and 4b, which are mounted rotatably on swivel arm 2. In the closed position, the two rollers 4a and 4b are arranged beside one another with regard to longitudinal direction X-X (see FIGS. 2 and 4), after the swivelling of swivel arm 2, the two rollers 4a and 4b are arranged beside one another obliquely to transverse direction Y-Y in the example of embodiment shown.

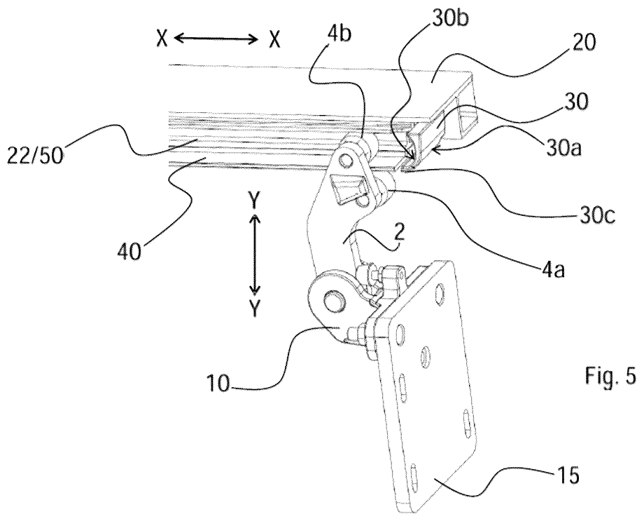

First roller 4a can assume two different positions, i.e. a first position in which roller 4a is arranged in front of guide rail 20 in the opening direction of leaf 42 (see FIG. 4) and a second position in which roller 4a is arranged beside roll-off wall 40, i.e. between the opening or for example a vehicle outer wall and roll-off wall 40 (see FIG. 5).

Deflection element 30 thus has outer contour 30a on it outer side and stop face 30b on its inner side. In the first position of swivel arm 2, the closed position of leaf 42, deflection element 30 is arranged between the two rollers 4a, 4b.

Swivel arm 2 is designed as an angled element, as a result of which the two rollers 4a, 4b in relation to the opening are arranged offset outwards with respect to bearing bolt 3. The swivel arm forms a first section 2a, which in the first position runs roughly parallel to longitudinal direction X-X and transforms into a second section 2b, which runs roughly in transverse direction Y-Y angled off roughly 45° to section 2a.

FIG. 4 illustrates the opening movement of leaf 42 already described above: If leaf 42 and therefore guide rail 20 is moved in the X-direction from the closed position into the open position (to the left in the representation according to FIG. 4), outer contour 30a of deflection element 30, through contact with roller 4a, and the traction of roll-off wall 40 on inner second roller 4b generate a rotation of swivel arm 2 in the direction pointing away from the opening or from the vehicle (in the anticlockwise direction in the example of embodiment shown), as a result of which the guide system and leaf 42 thus move in a defined manner in the Y direction. Leaf 42 then moves offset in parallel further in the X-direction and is displaced parallel to the vehicle outer wall.

FIG. 5 illustrates the closing movement of leaf 42: If leaf 42, and therefore rail 20, is moved in longitudinal direction X-X from the open position into the closed position (to the left in the representation according to FIG. 5), inner second roller 4b of swivel arm 2 comes into contact with inner stop face 30b and is entrained by the latter. This is only possible if outer first roller 4a has travelled over point 30c shown in FIG. 5, so that the above-dead-centre barrier can be overcome in the opened state. Outer first roller 4a can thus travel on outer contour 30a of deflection element 30 until it is positioned in the closed position in front of guide rail 20 or deflection element 30, as shown in FIG. 4 (laterally inverted to FIG. 5). In this position, first roller 4a can be in contact with deflection element 30 or spaced apart from deflection element 30.

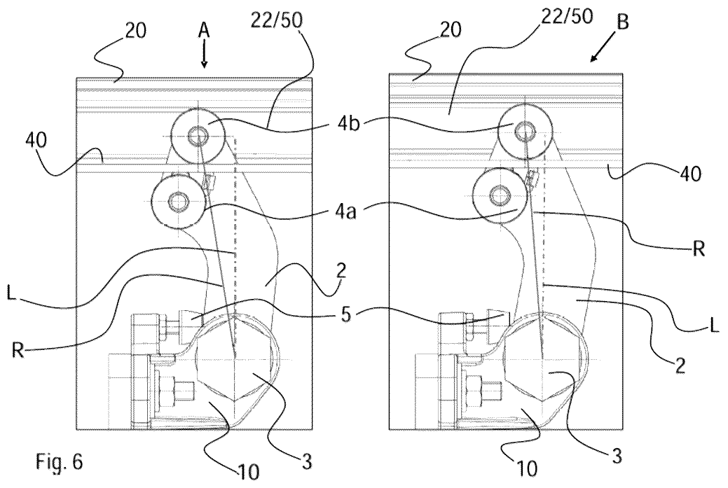

FIG. 6 shows that swivel arm 2 creates a barrier in the open position. Due to the inherent weight of leaf 42, distance A results (left-hand side of FIG. 6), in which only inner first roller 4b abuts against roll-off wall 40 and an end buffer 5 against swivel arm 2. The inherent weight of leaf 42 acts in the direction of the door, because leaf 42 is mounted swivellable about a rotary point in the door drive above the door opening. The rotary point is arranged in the vehicle interior, whereas the door leaf is parallel-offset thereto outside the vehicle. Leaf 42, on account of its inherent weight in particular in its lower region, thus brings about a force in the direction of the door opening.

Leaf 42 can be pushed outwards by vandalism or very severe tilting of the vehicle (state b, right-hand side in FIG. 6), as a result of which swivel arm 2 rotates, in the example of embodiment shown, about several degrees in the clockwise direction. The pressure acting in the y-direction causes swivel arm 2 to twist somewhat, until inner roller 4b also comes into contact and stops the rotation.

The play thus arising, however, is then limited or minimised by contact of first outer roller 4a, which then presses against roll-off wall 40 from outside. Inner first roller 4a continues to lie internally against roll-off wall 40. The contact of swivel arm 2 with end buffer 5 is no longer present in this situation.

Swivel arm 2 is blocked in the opened position, it cannot rotate over its own centre point, since the contact points of rollers 4a, 4b prevent this. Only when rollers 4a, 4b reach deflection element 30 can swivel arm 2 rotate again.

Since leaf 42 is always displaced in a coordinated manner in the X-and Y-direction by the drive system, the guide system is always guided in a defined manner in the Y-direction via deflection element 30 or outer contour 30a and stop face 30b.

For the open position of leaf 42, buffer 5 clearly shown in FIG. 3 represents a stop. For a defined run-in into the closed position, an anti-lift device is also fitted to an underside of the swivel arm 2, which is supported on leaf 42 in the closed position. FIG. 7 shows anti-lift device 6 and leaf 42 from inside. In the example of embodiment shown, anti-lift device 6 has a roughly cuboid shape, which during the movement of leaf 42 comes to bear at the underside on a horizontally aligned face 44 of leaf 42 when leaf 42 is raised. In the example of embodiment shown, anti-lift device 6 is guided in a groove, which extends beneath guide rail 20 and parallel thereto. Raising or lifting-out of leaf 42 is thus eliminated.

1. A system with a leaf for closing an opening, which is arranged in a frame, the system comprising:
a swivel arm arranged fixed on the frame and swivellable about a vertical axis, the free end of which is guided on the leaf in a guide rail extending along a longitudinal direction into an opening direction and which is aligned in a closed position of the leaf in a first position roughly in longitudinal direction and in an open position of the leaf in a second position roughly in a transverse direction;
a deflection element on the guide rail, which is designed and arranged such that it brings about a swivelling of the swivel arm from its first position into its second position and a movement of the leaf in transverse direction, when the leaf is moved out of the closed position into an open position and the free end of the swivel arm contacts the deflection element; and
a stop face in the guide rail, which is designed and arranged such that the free end of the swivel arm comes to bear on the stop face when the leaf moves out of the open position in the closing direction and brings about swivelling of the swivel arm from its second position into its first position and a movement of the leaf in transverse direction.

2. The system according to claim 1, wherein
the swivel arm comprises a first roller and a second roller, which also each rotate about vertical axis,
the guide rail comprises a roll-off wall extending parallel to the main extension of the leaf along longitudinal direction X-X and a stop face arranged at a front end of the guide rail in the opening direction of the leaf,
a starting wedge pointing in the opening direction as a deflection element is arranged in the opening direction of the leaf at the front end of the guide rail and at the rear side of the stop face,
wherein
the first roller is arranged outside the guide rail, such that in the closed position of the leaf it is arranged in front of the starting wedge in the opening direction,
the second roller is arranged inside the guide rail behind the roll-off wall and rolls off on the roll-off wall,
the components of the system are arranged and aligned with one another such that, when there is a movement of the leaf
a. out of the closed position in the opening direction, the first roller rolls off onto the starting wedge and brings about swivelling of the swivel arm from the first position into the second position,
b. out of the open position in the closing direction, the second roller comes to bear on the stop face and brings about swivelling of the swivel arm from the second position into the first position.

3. The system according to claim 1, wherein the starting wedge is formed by a deflection element with a convex outer contour.

4. The system according to claim 2, wherein the first position of the swivel arm the two rollers are arranged beside one another in respect of longitudinal direction X-X and in the second position are arranged beside one another obliquely to transverse direction Y-Y.

5. The system according to claim 2, wherein the guide rail forms a guide track, in which the second roller is guided, wherein the guide track comprises a groove , which is limited on its side facing the opening by the roll-off wall and wherein the second roller is guided in the groove and rolls off on the inner side of the roll-off wall.

6. The system according to claim 2, wherein the deflection element forms the outer contour on it outer side and the stop face on its inner side, wherein in the first position of swivel arm, the deflection element is arranged between the two rollers.

7. The system according to claim 2, wherein the swivel arm is designed as an angled element with a first section, which in the first position runs roughly parallel to longitudinal direction X-X and transforms into a second section, which runs roughly in transverse direction Y-Y angled off roughly 45° to section.

8. The system according to claim 1, wherein the leaf is formed by a door leaf of a vehicle and the opening by a door opening of the vehicle.

9. A method for opening and closing an opening which is arranged in a frame, the method including the following steps:
a) opening procedure
moving a leaf, which closes the opening, out of a closed position in the direction of an open position along a longitudinal direction, so that a guide rail extending along the longitudinal direction into an opening direction with a deflection element arranged at the front end of the guide rail in the opening direction comes to bear on a free end of a swivel arm arranged fixed on the frame and swivellable about a vertical access and thus, with further movement of the latter from its first position into its second position, brings about a movement of the leaf in the transverse direction out of the opening, and
further movement of the leaf in the longitudinal direction until in its final open position,
b) closing procedure
moving the leaf out of the open position in the direction of the closed position along the longitudinal axis until a stop face in the guide rail comes to bear on the free end of the swivel arm and brings about swivelling of the swivel arm from its second position into its first position and a movement of the leaf in the transverse direction in the direction of the opening, and
further movement of the leaf until in its final closed position.

10. The method according to claim 9, whereby the leaf is formed by a door leaf of a vehicle and the opening by a door opening of the vehicle.
